(19) United States
(12) Patent Application Publication
(10) Pub. No.: US 2010/0227940 A1
(43) Pub. Date: Sep. 9, 2010

(54) Composition Photoréticulable

(75) Inventors: Olivier Pinto, Lyon (FR); Jérôme Alric, L'Isle D' Abeau (FR)

Correspondence Address: SOFER & HAROUN LLP., 317 MADISON AVENUE, SUITE 910, NEW YORK, NY, 10017, US

(73) Assignee: NEXANS, Paris (FR)

(21) Appl. No.: 12/225,362

(22) PCT Filed: Mar. 19, 2007
(86) PCT No.: PCT/FR2007/050945

§ 371 Date: Sep. 18, 2008

(30) Foreign Application Priority Data
Mar. 23, 2006 (FR) 0651002

(51) Int. Cl. C08F 2/50; B29C 47/00

(52) U.S. Cl. 522/12; 522/46; 264/446

(57) ABSTRACT

The invention provides a photo-crosslinkable composition comprising:
a base polymer selected from olefin homopolymers or copolymers, or mixtures thereof;
a cross-linking agent; and
a photoinitiator;
characterized in that said photoinitiator is a compound with formula I:

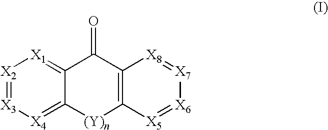

in which:
X₁ to X₈ respectively represent CR₁ to CR₈;
R₁ to R₈ are identical or different and represent a hydrogen atom or a halogen atom or OH or C(═O)R₉ or C(═O)OR₁₀ or SO₃⁻ or an aryl group, preferably a phenyl group, or an acryloyloxy group or a linear or branched C₁₋₁₂ alkyl group;
R₉ and R₁₀ are identical or different and represent a hydrogen atom or a linear or branched C₁₋₁₂ alkyl group;
n represents an integer equal to 0, 1 or 2;
when n equals 0, formula I is selected from 9-fluorenone and its derivatives;
when n equals 1;
   either Y represents a methylene group or a CHR₁₁ group, R₁₁ representing a hydrogen atom or a halogen atom or OH or C(═O)R₉ or C(═O)OR₁₀ or a linear or branched C₁₋₁₂ alkyl group;
   or Y and X₄ or Y and X₅ together form an aryl group, preferably phenyl;
when n equals 2, Y represents a methylene group.

The present invention relates to a photo-cross-linkable composition, to an electrical and/or optical cable including at least one cross-linked layer obtained from said composition, and to various methods of employing said composition.

It is typically applicable to the production of insulating or sheathing materials for electrical and/or optical cables.

In one embodiment, said composition is used in the automobile industry, in particular to insulate class C electrical cables, also known as class T3 cables. That class makes reference to the thermomechanical performance of the insulator within the meaning of International Standard ISO 6722. Thus, it is necessary to cross-link the insulator to improve its performance and in particular its high temperature behavior.

United States patent application US-2001/0041773 proposes a composition that is photo-crosslinkable by ultraviolet light. More particularly, that composition comprises an elastomer, a cross-linking agent of the acrylate or methacrylate type and a photoinitiator selected from organic compounds that are routinely employed to initiate the formation of radicals under ultraviolet light, either by homolytic cleavage of intramolecular bonds or by intermolecular liberation of a hydrogen atom.

In particular, the photoinitiators used in that document are a mixture of 1-hydroxycyclohexyphenylketone and bis(2,6-dimethoxybenzoyl)-2,4,4-trimethylphenyl-phosphine oxide or 1-hydroxycyclohexylphenyl ketone, those two compounds being respectively designated Irgacure 1800 or Irgacure 184 by Ciba Geigy Ltd.

In addition, other phenylketone photoinitiators are mentioned in that patent document, such as anthraquinone, xanthone and thioxanthone.

However, that photo-crosslinkable composition, comprising one or more of said phenylketone type photoinitiators, cannot produce an acceptable degree of cross-linking. Thus, the insulating material formed using that cross-linked composition does not exhibit sufficient hot creep resistance under mechanical load.

The invention aims to overcome the problems of the prior art by proposing a photo-crosslinkable composition that is capable of being used as an insulating layer in cables, said cross-linked composition having a significantly improved degree of cross-linking and significantly improved mechanical properties.

To this end, the invention provides a photo-crosslinkable composition comprising:
a base polymer selected from olefin homopolymers or copolymers or mixtures thereof;
a cross-linking agent; and
a photoinitiator;

said photoinitiator being a compound with formula I:

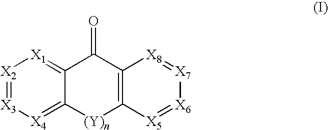

in which:
X₁ to X₈ respectively represent CR' to CR₈;
R₁ to R₈ are identical or different and represent a hydrogen atom or halogen atom or OH or C(═O)R₉ or C(═O)OR₁₀ or SO₃⁻ or an aryl group, preferably a phenyl group, or an acryloyloxy group or a linear or branched C₁₋₁₂ alkyl group;
R₉ and R₁₀ are identical or different and represent a hydrogen atom or a linear or branched C₁₋₁₂ alkyl group;
n represents an integer equal to 0, 1 or 2;
when n equals 0, formula I is selected from 9-fluorenone and its derivatives;
when n equals 1;
   either Y represents a methylene group or a CHR₁₁ group, R₁₁ representing a hydrogen atom or a halogen atom or OH or C(═O)R₉ or C(═O)OR₁₀ or a linear or branched C₁₋₁₂ alkyl group;
   or Y and X₄ or Y and X₅ together form an aryl group, preferably phenyl;
when n equals 2, Y represents a methylene group.

In another aspect of the present invention, the photo-crosslinkable composition comprises:
a base polymer selected from olefin homopolymers or copolymers, or mixtures thereof;
a cross-linking agent; and
a photoinitiator;

characterized in that said photoinitiator is a compound with formula II:

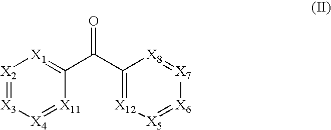

X₁ to X₉, X₁₁ and X₁₂ respectively represent CR₁ to CR₈, CR₁₁ and CR₁₂, and
at least one of groups R₁ to R₈, R₁₁, or R₁₂ is an aryl group, preferably a phenyl group, or an acryloyloxy group.

Clearly, the other remaining groups R₁ to R₈, R₁₁, or R₁₂ may be identical or different and may represent a hydrogen or a halogen atom or OH or C(═O)R₉ or C(═O)OR₁₀ or SO₃⁻ or an aryl group, preferably a phenyl group, or an acryloyloxy group or a linear or branched C₁₋₁₂ alkyl group, groups R₉ and R₁₀ being as defined in formula I.

In accordance with another aspect of the present invention, the photo-crosslinkable composition comprises:
a base polymer selected from olefin homopolymers or copolymers, or mixtures thereof;
a cross-linking agent; and
a photoinitiator;

said photoinitiator being a polymer comprising 2 to 100 elementary motifs with formula III:

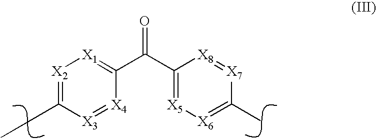

groups X₁ to X₈ being as defined in formula I.

By means of the invention, in particular the use of novel aromatic ketone type photoinitiator structures, the degree of cross-linking of the composition is substantially improved.

The document by Qu B. J., Xu Y., Ding L., and Ranby B. entitled “A new mechanism of benzophenone photoreduction in photoinitiated crosslinking of PE and its model compounds”, J. Appl. Pol. Sci., Part A: poll. Chem., 38,999 (2000) presents a benzophenone photoreduction mechanism that permits the photo-crosslinking of high density polyethylene (PE).

Firstly, the photoinitiator, benzophenone, is photoactivated by ultraviolet light. Next, the benzophenone, being in a triplet state, liberates a photon from the PE in order to form a PE macro-radical. Finally, photo-crosslinking of PE occurs by the formation of a carbon-carbon bond between two PE macro-radicals.

However, the authors of that document have demonstrated that the PE cross-linking reaction competes with the reaction of radical recombination of the PE macro-radical with the diphenylhydroxymethyl radical to form alpha-alkylbenzydrol type species. Once that occurs, PE cross-linking can be affected.

Now, surprisingly, the Applicant has discovered, in accordance with the present invention, that the use of aromatic ketones with formula I, II and polymer type aromatic ketones comprising 2 to 100 elementary motifs with formula III greatly limits or even prevents any recombination reactions between a macro-radical of the base polymer and the radical of the photoinitiator of the invention due to steric hindrance of said photoinitiator, and thus produces a composition that can be photo-cross-linked to a high degree of cross-linking.

Particularly advantageously, the photoinitiator with formula I is selected from dibenzosuberone, anthrone, benzoanthrone, 9-fluorenone and mixtures thereof.

Particularly advantageously, the photoinitiator with formula II is 4-phenylbenzophenone or 4-acryloxybenzo-phenone.

Particularly advantageously, the number of elementary motifs with formula III is in the range 2 to 10.

In accordance with a preferred characteristic, the terminal motifs of said polymer are hydrogen groups.

In accordance with a preferred characteristic, the polymer type photoinitiator has a molecular mass of about 960 g/mol [grams/mole].

In one embodiment, the cross-linking agent comprises at least one photoreactive functional group selected from acrylates, methacrylates, vinyls, allyls, and alkenyls.

In particular, the cross-linking agent comprises at least two photoreactive functional groups; preferably, the cross-linking agent is trimethylolpropane trimethacrylate.

Thus, cross-linking is carried out by means of a mechanism involving radical addition of photoreactive functional groups of the cross-linking agent to base polymer macro-radicals, said macro-radicals being formed by the action of a photoinitiator exposed to ultraviolet light.

In accordance with one characteristic of the invention, the base polymer is polyethylene or an ethylene copolymer.

In another embodiment, the cross-linking agent further comprises a hydrolysable functional group, preferably selected from alkoxysilane and carboxysilane groups.

In a particular example, the cross-linking agent is trimethoxysilyl propyl methacrylate.

Trimethoxysilyl propyl methacrylate, comprising a photoreactive methacrylate type functional group and a hydrolysable carboxysilane type functional group, grafts to a base polymer macro-radical by means of a mechanism of radical addition of its methacrylate group.

The composition further includes a catalyst for the condensation reaction of the silanol groups, preferably dibutyltin dilaurate.

The catalyst can accelerate cross-linking of the silane graft base polymer in a moist medium.

The silane graft base polymer is cross-linked by means of a mechanism of hydrolysis condensation of the silane group of said cross-linking agent.

In accordance with a further characteristic, the concentration of photoinitiator is less than 10% of the composition weight, preferably less than 5%.

As the concentration of photoinitiator increases, the depth of cross-linking becomes more limited because of a “barrier” effect, a consequence of the absorption of light by said photoinitiator.

In accordance with a further characteristic, the concentration of the cross-linking agent is less than 10% of the composition weight, preferably less than 5%.

This limit means that it is impossible to avoid a drop in the degree of cross-linking in the event that the concentration of cross-linking agent exceeds an optimum, which optimum is located at a concentration of more than 10% of the composition weight.

In a particular embodiment, the composition further comprises a Norrish type I photoinitiator. This type of photoinitiator is known to be capable of initiating the formation of radicals under ultraviolet light by homolytic cleavage of its intramolecular bonds.

Examples of said photoinitiator are of the alpha-hydroxyketone, phenyl glyoxylate, benzyldimethyl dimethylketal, bis-acylphosphine, or mono-acylphosphine type.

The invention also provides a first process intended to produce a cross-linked layer by a photochemical pathway, comprising the following steps:

i) extruding a composition of the invention to obtain an extruded layer; and

ii) cross-linking said extruded layer using ultraviolet light.

Advantageously, irradiation of the extruded layer with ultraviolet light is carried out continuously, directly after the step of extruding the composition.

Photochemical cross-linking is easy to carry out and the productivity of this type of process is substantially improved thereby.

The invention also provides a second process for producing a cross-linked layer by condensation of silanol groups, comprising the following steps:

i) irradiating, with ultraviolet light, a composition in accordance with the invention comprising a cross-linking agent comprising a hydrolysable functional group of the alkoxysilane or carboxysilane type, to obtain a graft base polymer;

ii) extruding said graft base polymer in the presence of a catalyst for the silanol group condensation reaction, preferably dibutyltin dilaurate, to obtain an extruded layer; and

iii) cross-linking said extruded layer in the presence of water.

Advantageously, the risk of gel formation by premature cross-linking due to a high moisture content is avoided by adding the catalyst in a step that is only carried out once the graft base polymer has been obtained, namely in step ii).

Step i) can produce, by a photochemical pathway, a base polymer grafted with said silane-functionalized cross-linking agent.

The final step, step iii), of this process can produce the cross-linked silane graft base polymer with an optimized degree of cross-linking.

Cross-linking is generally triggered in the presence of a large quantity of water and by heat. This cross-linking step is generally known as the “water bath” or “sauna” step.

Further, steps i) and ii) of the process may be continuous or otherwise.

The invention also provides a third process intended for the production of a layer cross-linked by condensation of silanol groups, comprising the following steps:

i) extruding a composition in accordance with the invention comprising a cross-linking agent comprising a hydrolysable functional group of the alkoxysilane or carboxysilane type, in the presence of a catalyst for the silanol group condensation reaction, preferably dibutyltin dilaurate, to obtain an extruded layer;

ii) irradiating said extruded layer with ultraviolet light; and

iii) cross-linking said extruded layer in the presence of water.

Step ii) allows the production, by a photochemical pathway, of a base polymer grafted with said silane-functionalized cross-linking agent.

Step iii) allows cross-linking of the silane-grafted base polymer of the composition of step ii). This step is identical to step iii) of the second process.

The second and third processes use a photochemical pathway to graft the silane-functionalized cross-linking agents.

Thus, the risk of premature cross-linking of the base polymer in the equipment during the extrusion step is considerably reduced.

Gel formation by premature cross-linking is a common problem encountered in thermal silane grafting reactions of the SIOPLAS type process described in U.S. Pat. No. 3,646,155, wherein a step of initiation by thermal decomposition of a peroxide is necessary.

The invention also provides a fourth process intended to produce a cross-linked layer by a photochemical pathway and by condensation of silanol groups, comprising the following steps:

i) irradiating, with ultraviolet light, a composition in accordance with the invention comprising a cross-linking agent comprising a hydrolysable functional group of the alkoxysilane or carboxysilane type, to obtain a graft base polymer;

ii) mixing the graft base polymer with a cross-linking agent comprising at least two photoreactive functional groups selected from acrylates, methacrylates, vinyls, allyls, and alkenyls;

iii) extruding the mixture in the presence of a catalyst for the silanol group condensation reaction, preferably dibutyltin dilaurate, to obtain an extruded layer;

iv) cross-linking said extruded layer using ultraviolet light, then in the presence of water.

Advantageously, the fourth process can improve the degree of cross-linking of the composition by combining two cross-linking modes during step iv).

The extruded layer is cross-linked not only by irradiation with ultraviolet light by means of adding the cross-linking agent in step ii), but also by condensation of the silanol groups in the presence of water because of the presence of the silane-functionalized cross-linking agent.

Cross-linking of the extruded layer is initially carried out by irradiating it with ultraviolet light at the exit from the extruder when said layer is still in the fused state.

Next, the extruded layer is cross-linked in the presence of water, in identical manner to step iii) of the second process.

Further, step i) of this fourth process allows a graft base polymer to be formed with the silane-functionalized cross-linking agent.

It is important to note that said step i) concerning irradiation of said composition with ultraviolet light may be replaced by a conventional step of grafting using heat, the aim being to obtain a silane graft base polymer at the end of step i).

The invention also proposes an electrical and/or optical cable comprising at least one cross-linked layer, said layer being obtained from the composition of the invention.

The composition of the invention is extruded onto the electrical and/or optical cable and cross-linking is then triggered, depending on the type of cross-linking agent used, by ultraviolet light and/or by the presence of water.

Other characteristics and advantages of the present invention become apparent from the following examples, said examples being given purely by way of non-limiting illustration.

In order to demonstrate the advantages obtained with the compositions of the invention, Table 1 details the various samples the thermomechanical properties of which were studied.

In this regard, it should be noted that the quantities mentioned in Table 1 are expressed in parts by weight per 100 parts of base polymer.

Sample 1 corresponds to a prior art composition. Samples 2 to 6 concern compositions in accordance with the invention comprising a photoinitiator with formula I.

TABLE 1

| | Constituents | | | | | | | | |
|---|---|---|---|---|---|---|---|---|---|
| | | | | | | | | LFC | |
| Sample | HDPE | LLDPE | EVA | TMPTMA | EBDA | DTMPTA | MAMO | 1234 | DBS |
| 1 | 100 | | | 5 | | | | 1 | |
| 2 | 100 | | | 5 | | | | | 1 |
| 3 | 100 | | | | 5 | | | | 1 |
| 4 | 100 | | | | | 5 | | | 1 |
| 5 | 70 | | 30 | 5 | | | | | 1 |
| 6 | | 100 | | | | | 1.6 | | 1 |

The origins of the various constituents is as follows:
HDPE corresponds to Borstar HE6063 high density polyethylene sold by Borealis;
LLDPE corresponds to LLDPE 1004 linear low density polyethylene sold by Exxon Mobil Chemical;
EVA corresponds to Escorene UL119 ethylene/vinyl acetate copolymer sold by ExxonMobil Chemical;
TMPTMA corresponds to trimethylolpropane trimethacrylate sold by Cray Valley under the designation SR350;
EBDA corresponds to ethoxylated bisphenol A diacrylate sold by Cray Valley under the designation SR349;
DTMPTA corresponds to di-trimethylolpropane tetracrylate sold by Cray Valley under the designation SR355;
MAMO corresponds to trimethoxysilyl propyl methacrylate sold by Witco under the designation Silquest A-174;
LFC 1243 corresponds to a benzophenone derivative sold by Lamberti;
DBS corresponds to dibenzosuberone sold by Aldrich.

The samples were prepared using the following protocol, the temperature being set at 150° C. throughout mixing:
introducing base polymer into a kneader adjusted to 30 rpm [revolutions per minute];
fusing base polymer at 150° C. for 2 minutes at 30 rpm then at 60 rpm;
introducing cross-linking agent at 30 rpm;
mixing at 30 rpm for approximately 5 minutes;
introducing photoinitiator at 30 rpm; and
mixing at 30 rpm for approximately 5 minutes.

The mixture could also be produced in a twin screw or Buss type extruder.

Next, the samples were extruded in the form of a continuous ribbon using a single-screw extruder with a head carrying a ribbon die and four heating zones in the oven at 120° C., 140° C., 155° C., and 165° C.

In sample 6, the extruded mixture contained 350 ppm [parts per million] of dibutyltin dilaurate catalyst. The catalyst was added during the extrusion step in the form of a master mixture of polyethylene containing 0.69% of said catalyst.

The thickness of the ribbon obtained was kept between 0.6 mm [millimeter] and 0.8 mm regardless of the sample.

Next, the ribbon obtained was immediately irradiated with ultraviolet light at a throughput of 4.4 meters per minute using an LC6E type conveyor sold by Fusion UV systems and provided with a medium pressure type “D” mercury vapor bulb with a power of 240 W/cm [watt/centimeter].

Sample 6, following said irradiation step, was cross-linked by immersion in water at 80° C. for 12 hours to reproduce cross-linking conditions known as “sauna” conditions.

Finally, the ribbons corresponding to samples 1 to 6 were cooled and their thermomechanical properties, which are characteristic of the degree of cross-linking obtained, were measured, namely hot creep under mechanical load and the percentage of insolubles.

French standard NF EN 60811-2-1 provides the measurement of the hot creep of a material under mechanical stress.

Hot creep consists of loading one end of a H2 dumbbell type sample with a mass corresponding to the application of a load equivalent to 0.2 MPa [megapascal], and placing the ensemble in an oven heated to 200° C.±1° C. for a period of 15 minutes.

After this period, the hot extension under load of the sample is recorded as a %. The suspended mass is then removed and the sample is kept in the oven for a further 5 minutes. The remaining permanent extension, also termed remanence, is then measured before being expressed as a %.

It is important to note that the more cross-linked the material, the lower the extension and remanence values.

Further, it should be stated that when a sample breaks during a test under the joint action of the mechanical load and temperature, the test result is considered to be a failure.

A partially cross-linked material is composed of a proportion of insoluble material, also termed the gel content, and a proportion of soluble material, also termed the sol.

Thus, in order to determine the degree of cross-linking for each sample, the proportion of insoluble material is determined.

The mode of operation was identical for each measurement and can be summarized as follows:
1 g [gram] of the study sample (M₁) was placed in an Erlenmeyer flask containing 100 g of xylene and approximately 0.05 g of an antioxidant, typically the product Irganox 1010 sold by Ciba;
the Erlenmeyer was heated to 110° C. with magnetic stirring for a period of 24 h [hour];
the contents of the Erlenmeyer were then hot filtered over a metal screen with a mesh size of 120 μm [micrometer]×120 μm;
the solid residue obtained was then dried in an oven at 100° C. for 24 h, and then weighed (M₂).

The percentage of insolubles, expressed as a %, was calculated using the ratio of the masses, M₂×100/M₁.

Table 2 summarizes the results for hot creep and the percentage of insolubles obtained with the six specimens defined in Table 1.

TABLE 2

| | | Hot creep | | |
|---|---|---|---|---|
| | Sample | Extension | | Percentage of |
| | thickness | under load | Remanence | insolubles |
| Sample | (mm) | (%) | (%) | (%) |
| 1 | 0.70 | Fail, breakage of | | 42 |
| | | sample | | |
| 2 | 0.70 | 35 | 0 | 58 |
| 3 | 0.60 | 75 | 0 | 59 |
| 4 | 0.70 | 80 | 5 | 61 |
| 5 | 0.75 | 100 | 5 | 48 |
| 6 (J₀) | 0.70 | Creep | | 0 |
| 6 (J_{inf}) | 0.70 | 80 | 20 | 60 |

In sample 6, the thermomechanical characterizations were carried out initially on the extruded and irradiated composition with reference 6 (J₀) and then after cross-linking in the presence of water, with reference 6 (J_{inf}).

A comparison of prior art sample 1 with specimens 2, 3, 4, 5, and 6 (J_{inf}) of the invention shows the advantageous performances as regards thermomechanical properties, including the degree of cross-linking, of the composition of the invention.

In contrast to sample 1 which failed the creep test because it broke during the 15 minute period in the oven, samples 2, 3, 4, 5, and 6 (J_{inf}) exhibited very good hot creep properties under load.

Further, the percentage of insolubles in samples 2, 3, 4, 5, and 6(J_{inf}) of the order of 60%, was substantially higher than that of sample 1, of the order of 40%.

Thus, the degree of cross-linking of the compositions of the invention was particularly optimized.

More particularly for sample 6 (J₀), it should be noted that, particularly advantageously, the percentage of insolubles was zero at the extruder exit; premature cross-linking of said sample during the extrusion phase had thus been avoided.

Further, the silane groups had been effectively grafted photochemically, since the percentage of insolubles obtained for sample 6 (J_{inf}) after cross-linking it in the presence of water reached 60%.

Other tests of the same type were carried out with a composition of the invention further comprising fillers such as stabilizing agents and a flame retarding filler, said composition being extruded around a metallic conductor.

Table 3 details the sample the thermomechanical properties of which were studied.

The quantities mentioned in Table 3 are expressed in parts by weight per 100 parts of base polymer, i.e. per 100 parts by weight of the mixture of HDPE, EVA and Peg(MAH) polymers.

TABLE 3

| | Constituents | | | | | | | | |
|---|---|---|---|---|---|---|---|---|---|
| Sample | HDPE | EVA | Peg(MAH) | MDH | EBDA | DBS | 1010 | 1024 | PS802 |
| 7 | 60 | 30 | 10 | 120 | 11.4 | 1.3 | 2 | 2 | 1.5 |

The origin of the various constituents is as follows:
HDPE corresponds to Lupolen 5031L high density polyethylene sold by Basell;
EVA corresponds to Escorene ethylene/vinyl acetate copolymer sold by Exxon Mobil Chemical;
EVA corresponds to Escorene UL119 ethylene/vinyl acetate copolymer sold by ExxonMobil Chemical;
PEg(MAH) corresponds to Polybond 3009 maleic anhydride-grafted polyethylene sold by Dupont de Nemours;
MDH corresponds to Magnifin H10 magnesium hydroxide sold by Martinswerk;
EBDA corresponds to ethoxylated bisphenol A diacrylate sold by Sartomer under the designation SR349;
DBS corresponds to dibenzosuberone sold by Aldrich;
1010, 1024 and PS802 correspond to stabilizing agents with respective references Irganox 1010, Irganox MD1024 and Irganox PS802, sold by Ciba.

Sample 7 was prepared using a twin-screw LEISTRITZ extruder (L/D=36; diameter=27 mm [millimeter]).

The polymers, cross-linking agent, photoinitiator and fillers were added via the principal hopper of the extruder.

The sample was produced at a rate of 15 kg/h [kilogram/hour] with a screw speed of 100 rpm, the temperature profile being in the range 130° C. to 160° C.

The extruded sample was then cooled in a water bath and transformed into granules.

Next, said granules were extruded in the form of an insulating layer around a copper wire type electrical conductor 1.04 mm in diameter.

This extrusion step was carried out using a single-screw extruder provided with a crosshead through which said copper wire was passed at a speed of 30 m/min [meter/minute], the thickness of the insulation on the copper wire being approximately 350 μm.

The temperature profile established for the four heating zones in the extruder was 140° C., 150° C., 175° C. and 180° C.

Next, the insulated copper wire was irradiated with ultraviolet light by introducing it into a DRF10 (Fusion UV) type oven provided with at least one mercury vapor lamp (F600—240 W/cm) 25 cm long.

Table 4 shows the various conditions of the process for cross-linking the extruded layer obtained from sample 7 in accordance with the present invention.

To this end, the speed of the line in the irradiation oven UV and the number and intensity of the lamps in said oven were varied, the UV dose received per sample 7 being a function of these three parameters.

TABLE 4

| | Speed of line | Number of | Intensity of |
|---|---|---|---|
| | in oven | F600 lamps in | F600 lamps |
| Sample | (m/min) | oven | (%) |
| 7a | 30 | 1 | 60 |
| 7b | 50 | 1 | 100 |
| 7c | 100 | 1 | 100 |
| 7d | 100 | 2 | 100 |
| 7e | 200 | 2 | 100 |

Finally, the copper wires covered with an insulating layer and cross-linked, obtained from samples 7a to 7e were cooled in a water bath and recovered on a winding engine.

Their thermomechanical properties, characterizing the degree of cross-linking obtained, were measured in the same manner as with samples 1 to 6.

Table 5 shows the hot creep and percentage of insolubles results for specimens 7a to 7e obtained from sample 7.

TABLE 5

Hot creep

| | Layer | Extension | | Percentage of |
|---|---|---|---|---|
| | thickness | under load | Remanence | insolubles |
| | (mm) | (%) | (%) | (%) |
| 7a | 0.35 | 45 | 0 | 70 |
| 7b | 0.35 | 35 | 0 | 72 |
| 7c | 0.35 | 50 | 0 | 52 |
| 7d | 0.35 | 25 | 0 | 61 |
| 7e | 0.35 | 75 | 0 | 51 |

Specimens 7a to 7e exhibited very good hot creep under load properties.

It is important to note that sample 7e had a substantially identical percentage of insolubles to that of sample 7c for double the line speed, with two 100% intensity UV lamps.

Thus, the degree of cross-linking of the compositions of the invention has in particular been optimized.

The line speed may advantageously be increased to 500 m/min in the presence of 5 100% intensity UV lamps and produce a degree of insolubles substantially identical to samples 7c and 7e.

The present invention is not limited to the examples that have been described and in general pertains to any compositions that can be envisaged from the general indications provided in the disclosure of the invention.

The compositions in question are all capable of being used to produce insulating and/or sheathing and/or packing materials for power and/or telecommunication cables.

The composition may also comprise inorganic fillers, especially fire retarding fillers of the calcium hydroxide, magnesium hydroxide, aluminum trihydroxide or calcium carbonate type.

It may also contain one or more additives intended to improve one or more of its final properties. Any polymer additive that is known in the art may be used, such as plasticizers, antioxidants, UV stabilizing agents, coupling agents, dispersing agents, hydrophobic agents, etc.

Furthermore, other types of actinic radiation may be used in the context of the invention, such as a beam of electrons.

Further, the composition may comprise mixtures of photoinitiators of the invention and one or more Norrish I type photoinitiators.

Finally, the values given, functions of the percentages by weight of the composition, are not to be considered to have been provided in the manner of strict values and may vary within the tolerances that are usual to the skilled person.

1. A photo-crosslinkable composition comprising:
a base polymer selected from olefin homopolymers or copolymers, or mixtures thereof;
a cross-linking agent; and
a photoinitiator;
characterized in that said photoinitiator is a compound with formula I: 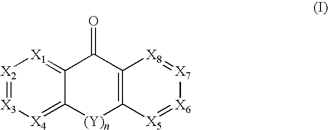
in which:
X₁ to X₈ respectively represent CR₁ to CR₈;
R₁ to R₈ are identical or different and represent a hydrogen atom or a halogen atom or OH or C(═O)R₉ or C(═O)OR₁₀ or SO₃⁻ or an aryl group, preferably a phenyl group, or an acryloyloxy group or a linear or branched C₁₋₁₂ alkyl group;
R₉ and R₁₀ are identical or different and represent a hydrogen atom or a linear or branched C₁₋₁₂ alkyl group;
n represents an integer equal to 0, 1 or 2;
when n equals 0, formula I is selected from 9-fluorenone and its derivatives;
when n equals 1;
either Y represents a methylene group or a CHR₁₁ group, R₁₁ representing a hydrogen atom or a halogen atom or OH or C(═O)R₉ or C(═O)OR₁₀ or a linear or branched C₁₋₁₂ alkyl group;
or Y and X₄ or Y and X₅ together form an aryl group, preferably phenyl;
when n equals 2, Y represents a methylene group.

2. A composition according to claim 1, wherein the photoinitiator is selected from dibenzosuberone, anthrone, benzoanthrone, 9-fluorenone and mixtures thereof.

3. A photo-crosslinkable composition comprising
a base polymer selected from olefin homopolymers or copolymers, or mixtures thereof;
a cross-linking agent; and
a photoinitiator;
characterized in that said photoinitiator is a compound with formula II: 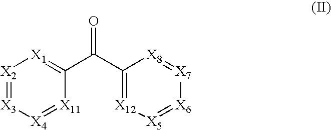
X₁ to X₈, X₁₁ and X₁₂ respectively represent CR₁ to CR₈, CR₁₁ and CR₁₂; and
at least one of groups R₁ to R₈, R₁₁ or R₁₂ is an aryl group, preferably a phenyl group, or an acryloyloxy group.

4. A composition according to claim 3, wherein the photoinitiator is 4-phenylbenzophenone or 4-acryloxybenzophenone.

5. A photo-crosslinkable composition comprising:
a base polymer selected from olefin homopolymers or copolymers, or mixtures thereof;
a cross-linking agent; and
a photoinitiator;
wherein the photoinitiator is a polymer comprising 2 to 100 elementary motifs with formula III: 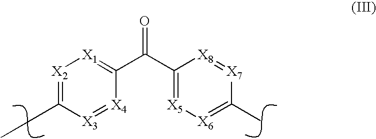
groups X₁ to X₈ being as defined in claim 1.

6. A composition according to claim 5, wherein the number of elementary motifs is in the range 2 to 10.

7. A composition according to claim 5, wherein the terminal motifs of the polymer are hydrogen groups.

8. A composition according to claim 5, wherein the photoinitiator has a molecular mass of approximately 960 g/mol.

9. A composition according to claim 1, wherein the cross-linking agent comprises at least one photoreactive functional group selected from acrylates, methacrylates, vinyls, allyls and alkenyls.

10. A composition according to claim 1, wherein the cross-linking agent further comprises a hydrolysable functional group, preferably selected from alkoxysilane and carboxysilane groups.

11. A composition according to claim 1, wherein the cross-linking agent is trimethoxysilyl propyl methacrylate.

12. A composition according to claim 10, wherein the composition further comprises a catalyst for the silanol group condensation reaction, preferably dibutyltin dilaurate.

13. A composition according to claim 1, wherein the cross-linking agent comprises at least two photoreactive functional groups; preferably, the cross-linking agent is trimethylolpropane trimethacrylate.

14. A composition according to claim 1, wherein the base polymer is polyethylene or an ethylene copolymer.

15. A composition according to claim 1, wherein the concentration of the photoinitiator is less than 10% of the composition weight, preferably less than 5%.

16. A composition according to claim 1, wherein the concentration of cross-linking agent is less than 10% of the composition weight, preferably less than 5%.

17. A composition according to claim 1, wherein the composition further comprises a Norrish type I photoinitiator.

18. An electrical and/or optical cable comprising at least one cross-linked layer, wherein said layer is obtained from a composition according to any preceding claim.

19. A process for producing a cross-linked layer, comprising the following steps:
i) extruding a composition according to claim 1 to obtain an extruded layer; and
ii) cross-linking said extruded layer using ultraviolet light.

20. A process for producing a cross-linked layer, comprising the following steps:
i) irradiating said composition in accordance with claim 10 with ultraviolet light to obtain a graft base polymer;
ii) extruding said graft base polymer in the presence of a catalyst for the silanol group condensation reaction, preferably dibutyltin dilaurate, to obtain an extruded layer; and
iii) cross-linking said extruded layer in the presence of water.

21. A process for producing a cross-linked layer, comprising the following steps:
i) extruding a composition in accordance with claim 10 in the presence of a catalyst for the silanol group condensation reaction, preferably dibutyltin dilaurate, to obtain an extruded layer;
ii) irradiating said extruded layer with ultraviolet light; and
iii) cross-linking said extruded layer in the presence of water.

22. A process for producing a cross-linked layer, comprising the following steps:
i) irradiating a composition according to claim 10 with ultraviolet light to obtain a graft base polymer;
ii) mixing the graft base polymer with a cross-linking agent comprising at least two photoreactive functional groups selected from acrylates, methacrylates, vinyls, allyls and alkenyls;
iii) extruding the mixture in the presence of a catalyst for the silanol group condensation reaction, preferably dibutyltin dilaurate, to obtain an extruded layer;
iv) cross-linking said extruded layer using ultraviolet light, then in the presence of water.
